(19) United States
(12) Patent Application Publication
(10) Pub. No.: US 2011/0030025 A1
(43) Pub. Date: Feb. 3, 2011

(54) High speed wireless video transmission

(75) Inventors: James G. Bertonis, Los Gatos, CA (US); Geoffrey L. Giese, Santa Clara, CA (US)

Correspondence Address: Silicon Valley Patent Group LLP;Attn: Bryan Wyman, 18805 Cox Avenue, Suite 220, Saratoga, CA, 95070, US

(73) Assignee: Azure Communications Inc., Los Gatos, CA (US)

(21) Appl. No.: 12/534,068

(22) Filed: Jul. 31, 2009

(51) Int. Cl. H04N 7/173; H04N 5/40; H04N 7/12

(52) U.S. Cl. 725/118; 348/724; 375/240.01; 348/E05.093; 375/E07.027; 375/E07.076

(57) ABSTRACT

An implementation of a system and method for wirelessly communicating a digital video signal is provided. The system automatically compensates to maintain the received signal integrity as a wireless path for the transmitted digital video signal deteriorates. This method adjusts both the video compression rate and the modulation index in tandem to maintain a constant symbol rate.

### CROSS-REFERENCE TO RELATED APPLICATIONS

Not Applicable.

### BACKGROUND OF THE INVENTION

1. Field of the Invention

The invention relates generally to wireless communications and more specifically to point-to-point or point-to-multipoint communication of wireless high definition digital video signals (e.g., wireless HDMI signals).

2. Background of the Invention

High definition television (HDTV), high definition Internet protocol streaming video (HD-IPTV) and other digital HD multimedia have historically been limited to wired transmission due to their extremely high data rate requirements. Often HD multimedia encoded data rates range from 100 Mbps (million bits per second) to more than 2 Gbps (billion bits per second), which results in few or no suitable wireless RF spectrum having a high enough bandwidth necessary to effectively carry this encoded information.

Existing technology used for wireless-HD multimedia systems lack performance in range, video quality and/or have line-of-sight limitations. These performance limitations result from adapting existing technologies, such as wireless local area networks (WLANs) or ultra-wide band (UWB) radio systems, to the vastly more rigorous bandwidth and performance requirements needed for HD multimedia signals. Such existing solutions using UWB, WLAN and 60-GHz based technologies each have these and other drawbacks.

An Ultrawideband (UWB) implementation has an advantage of high bandwidth and potentially high data rates. UWB radio systems are typically used indoors for wireless multimedia applications. Due to the FCC's transmit power limitations for UWB signals however, the range is limited to about 10 meters. Typically, such power limited UWB signals are inadequate when needing to penetrate through walls or obstructions or when requiring two-way communications.

A WLAN implementation has an advantage of two-way communications and allows for transmission over longer distances. Some radio system that use IEEE 802.11n and other WLAN based technologies have been modified and adapted to offer improved data throughput and minimum quality-of-service (QOS) capabilities in an attempt to meet HD multimedia transmission requirements. Several factors, such as low bandwidths, large overhead signaling-to-payload ratio and interference with other nearby Wi-Fi devices, may limit maximum data rates of these radio systems to rates below what is necessary for full compatibility with HD multimedia standards.

The license free 60-GHz band (59 to 66 GHz) offers potential for much greater bandwidth and ultra-high speed data rates. The FCC allows higher transmit power levels for these 60-GHz millimeter-wave based systems. The signal propagation characteristics at this frequency, however, limits reception to line-of-sight operations. Typically, such signals are inadequate to penetrate through walls, do not provide two-way communications and use proprietary signaling protocols. In addition, 60-GHz millimeter-wave radio systems are currently too expensive for incorporation into consumer electronics.

The above-described conventional systems have several disadvantages. Therefore, a need exists to for a wireless system to communicate HD digital video signals without one or more of these disadvantages.

### SUMMARY

Some embodiments of the present invention provide for a distribution transceiver for communicating a digital video signal, the transceiver comprising: a video compressor comprising (1) an input port to accept an input digital video signal, (2) digital compressing logic operable to compress the input digital video signal at a selected compression ratio, (3) an output port to provide a compressed digital video signal, and (4) a control input port couple to receive a control signal indicating the selected compression ratio; a video signal transmitter comprising (1) an input port configured to receive the compressed digital video signal from the video compressor, (2) a modulator, (3) an output port configured to transmit, on a downlink, an RF signal at a selected modulation rate, and (4) a control input port couple to receive a control signal indicating the selected modulation rate; and a video source controller comprising (1) a first port configured to provide the selected compression ratio as the control signal to the control input port of the video compressor, (2) a second port configured to provide the selected modulation rate as the control signal to the video signal transmitter, and (3) a third port configured to accept, from a uplink, a feedback signal; wherein, based on the feedback signal, the video source controller is configured to select a compression-rate/modulation-rate pair from a list of pairs having a common symbol rate; and wherein the downlink is narrower and independent from the uplink.

Some embodiments of the present invention provide for a downlink transceiver for communicating a digital video signal, the downlink comprising: a video signal receiver comprising (1) an input port configured to receive, on a downlink, a compressed digital video signal, (2) a demodulator, and (3) an output port configured to provide a demodulated signal; and a video decompressor comprising (1) an input port to accept the demodulated signal, (2) digital decompressing logic operable to decompress the demodulated signal, and (3) an output port to provide a decompressed digital video signal; a video sink monitor configured to (1) receive a signal indicating a signal quality, and (2) provide a feedback signal based on the signal quality; and a control signal transmitter configured to transmit, on an uplink, the feedback signal; wherein at least on of the signal receiver and the video decompressor further comprises and (4) a control output port couple to provide the signal indicating a signal quality; wherein the feedback signal is used to select a compression-rate/modulation-rate pair from a list of pairs having a common symbol rate; and wherein the downlink is narrower and independent from the uplink.

Some embodiments of the present invention provide for a method for distributing a digital video signal, the method comprising: setting a first compression-rate/modulation-rate pair comprising a selected compression rate and a selected modulation rate; and repeating acts of accepting an input digital video signal; compressing the input digital video signal at the selected compression rate, thereby providing a compressed digital video signal; modulating the compressed digital video signal at the selected modulation rate, thereby transmitting a wireless signal; receiving a feedback signal indicating a signal of merit of the wireless signal received at a downlink transceiver; selecting, from a list of pairs having a common symbol rate, a compression-rate/modulation-rate pair based on the feedback signal; and updating the selected compression rate and the selected modulation rate using the selected compression-rate/modulation-rate pair.

These and other aspects, features and advantages of the invention will be apparent by reference to the embodiments described hereinafter.

### BRIEF DESCRIPTION OF THE DRAWINGS

Embodiments of the invention will be described, by way of example only, with reference to the drawings.

FIG. 1 shows a block diagram of a wired HDMI system.

FIG. 2 shows a block diagram of a wireless HDMI system having a feedback signal, in accordance with embodiments of the present invention.

FIG. 3 shows an HDMI distribution system providing multiple digital video signals, in accordance with embodiments of the present invention.

FIGS. 4 and 5 show block diagrams of a wireless HDMI system having a feedback signal, in accordance with embodiments of the present invention.

FIG. 6 illustrates a spectrum containing a wideband downlink video signal and a narrow band uplink feedback signal.

FIGS. 7A, 7B, 7C, 7D and 7E show various predetermined pairings of compression ratios and modulation indexes, in accordance with embodiments of the present invention.

FIGS. 8, 9 and 10A show flow charts of operations in a HDMI distribution system, in accordance with embodiments of the present invention. FIG. 10B illustrate a process of changing which pair of compression ratio and modulation index is used, in accordance with embodiments of the present invention.

FIGS. 11 and 12 show block diagrams of wireless HDMI systems having multiple video signal input ports, in accordance with embodiments of the present invention.

FIGS. 13A and 13B illustrate spectrums containing wideband downlink video signals and narrow band uplink feedback signals.

FIG. 14 shows block diagrams of wireless HDMI systems having an HDMI monitor interface, in accordance with embodiments of the present invention.

FIG. 15 shows a hardware configuration for sending and receiving remote control commands, in accordance with some embodiments of the present invention.

### DETAILED DESCRIPTION OF THE INVENTION

In the following description, reference is made to the accompanying drawings, which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense. Furthermore, some portions of the detailed description that follows are presented in terms of procedures, steps, logic blocks, processing, and other symbolic representations of operations on data bits that can be performed in electronic circuitry or on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in electronic circuitry or in a computer system. These signals may be referred to at times as bits, values, elements, symbols, characters, terms, numbers, or the like. Each step may be performed by hardware, software, firmware, or combinations thereof.

Some embodiments of the present invention comprise a system including a high speed digital video input signal stream, a variable rate video encoder and decoder, a wireless transmitter and receiver with a fixed bandwidth, modulation and de-modulation with variable modulation index-QAM or other encoding, a one-way or two-way signaling path, and a closed-loop received signal analyzer. Embodiments may use the 5 GHz license free band, although any operating frequency containing appropriate bandwidths for video data rates may be utilized.

In one exemplary operating mode, video signal at a given data rate (for instance at 250 Mbps) is feed to a video variable rate encoder, which will apply a video compression algorithm (for example MPEG-4) to the signal. The rate chosen will be based on a decision made by a closed loop analyzer. Such a decision in part is based on feedback from the intended receiver derived from one or more received figure of merit indicators. For a given incoming data rate and compression rate, there is a mapped corresponding QAM modulation index such that the symbol rate over the channel bandwidth remains constant.

To illustrate this operation, a 250 Mbps signal is modulated in a variable rate QAM modulator over a 40 MHz RF bandwidth. During an initial period, assume the wireless path is relatively free of impairments. The signal analyzer chooses a 1:1 compression ratio (pass-through or no compression) and the signal is modulated using 256-QAM with a 250 Mbps rate. During a subsequent period, the signal analyzer determines that quality has fallen. The system adjusts the compression to a 2-to-1 ratio (2:1) and simultaneously the modulation index is changed to 16-QAM and the data rate is now 125 Mbps. During a next subsequent period, the wireless path is further impaired and the signal analyzer determines that a further adjustment is needed. The compression ratio is then adjusted to a 4-to-1 ratio (4:1) with a simultaneous modulation index change to QPSK with a 62 Mbps data rate. This process may be scaled to different data rates and RF bandwidths as necessary to adjust the process to work with various digital video data rates and environments.

As the wireless path for the transmitted digital video signal deteriorates, the system automatically compensates to maintain the received signal integrity. This process is performed by adjusting both the video compression rate and the modulation index in tandem. Although this process may introduce very subtle video effects, such as a minor loss of detail, such effects are subjectively acceptable compared to a partial or total loss of transmitted video, which would be the effect as the signal path deteriorated in absence of the use of this invention.

Currently, high-definition multimedia interface (HDMI) digital video signals are communicated using a wired connection between a HDMI source and an HDMI monitor. Digital video cables are limited by length due to the data rates of the digital video signals. For example, such cables may have a maximum length of 10 to 30 meters. Longer cables may lead to a degradation of video quality. Wireless transmitters may be used to replace a wired connection, however, current solutions have several disadvantages as explained herein.

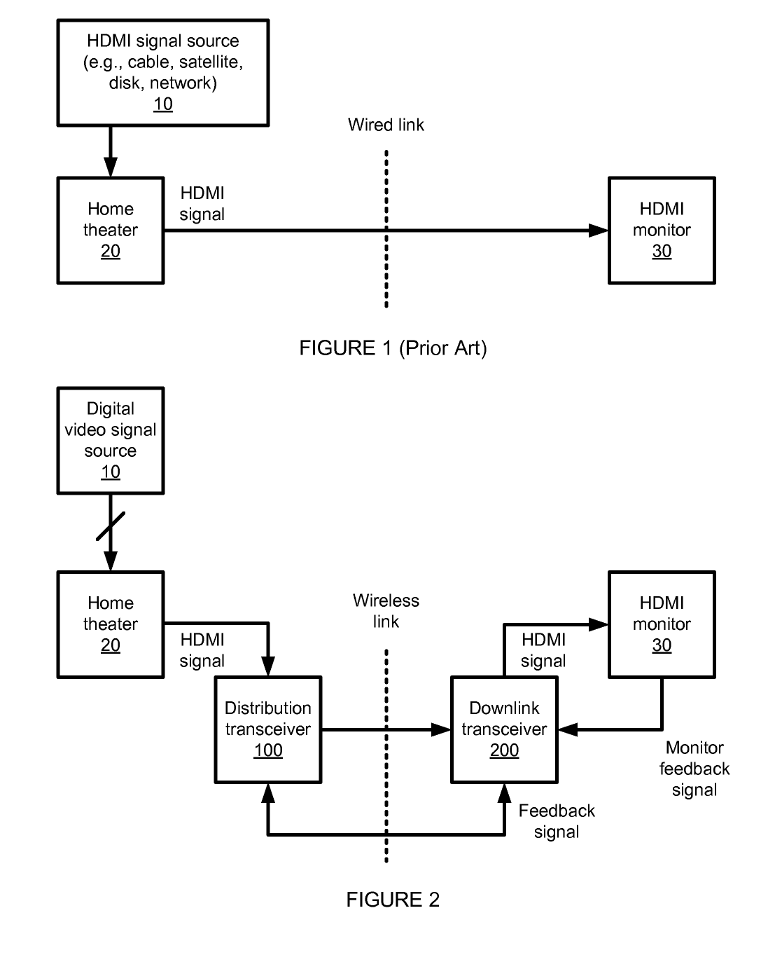

FIG. 1 shows a block diagram of a common end user's wired HDMI system. The HDMI system includes an HDMI signal source such as a home cable demodulator, satellite receiver, a home computer with a hard disk, and/or a wired network connection to a LAN or WAN. The HDMI system also includes an HDMI home theater system 20 and an HDMI monitor 30. The HDMI signal source 10 provide a demodulated baseband signal to the HDMI theater 20, which in turn provides an HDMI signal to the HDMI monitor 30 over a wired link or HDMI cable. A typical 5-GHz downlink digital video signal limits the distance an HDMI cable may span. Distances over a several feet or a few yards may require amplifiers, boosters, equalizers or other additional hardware in order to provide a fully compliant and high quality HDMI signal.

By replacing the wired link with a wireless link, several problems as described above may result but the distance between the HDMI home theater and the HDMI monitor may be increase above the several feet limitation. Though the figures and description below identify the HDMI standard as a digital standard for communicating a digital video signal, the present invention may be equally applied to other digital video signal standards.

FIG. 2 shows a block diagram of a wireless HDMI system having a feedback signal, in accordance with embodiments of the present invention. The system includes a digital video signal source 10, such as the HDMI signal source described above, a home theater 20 and an HDMI monitor 30, as shown in FIG. 1. In addition, the system includes a distribution transceiver 100 and a downlink transceiver 200. Rather than sending the HDMI signal to the monitor 20 via a wired link, the system of FIG. 2 uses a wireless link formed between the distribution transceiver 100 and a downlink transceiver 200.

Some embodiments of the present invention include two wireless links as shown in FIG. 2. A first link is a very high speed simplex link for the transmission of the digital video information, and the second link is a separate duplex link for control data/clock, handshaking, and feedback, hereinafter referred as a feedback signal. In other embodiments, the first and second links share a bandwidth that provides a higher data rate on the downlink and a lower data rate on the uplink. For example, the first and second links may be provided with a wireless local area network (WLAN) protocol (e.g. IEEE 802.11) or the like, where the downlink (occupied primarily by the digital video signal and slightly by the downlink portion of the feedback signal) uses most of the wireless channel bandwidth and the uplink (occupied by the uplink portion of the feedback signal) uses a small fraction of the bandwidth. In some embodiments, an uplink portion of the control data/clock, handshaking, and feedback signals are sent over a half-duplex WLAN link. In this case, the relative time duration of the uplink and downlink may be adjusted to provide maximum bandwidth to the direction sending and receiving the digital video signal, and minimal bandwidth for all of the other signals.

For example, assume that the channel bandwidth is split 99:1 such that 99 percent of the channel bandwidth is configured for downlink and the remaining 1 percent is configured for uplink. Also assume that 98 percent is allocated for the video signal on the downlink, 1 percent is allocated for the downlink portion of the feedback signal and 1 percent is allocated for the uplink portion of the feedback signal. Therefore, the resulting channel provides a high capacity downlink and a low capacity feedback signal (including low bandwidth signals on both the uplink and downlink).

The distribution transceiver 100 receives an HDMI signal from the home theater 20 then modulates and broadcasts it wirelessly to the downlink transceiver 200. The downlink transceiver 200 demodulates the HDMI signal then provided it as a wired signal to the HDMI monitor 30. From a perspective of the the HDMI monitor 30 even though a wireless link is used, the HDMI signal is being supplied directly from the home theater 20 via a wired link. The downlink transceiver 200 also generates a feedback signal that is much lower in bandwidth than the higher bandwidth, higher carrier frequency downlink signal.

For example, in some embodiments, the HDMI signal is transmitted using a 5 GHz downlink carrier frequency while the feedback signal is transmitted at 900 MHz using a very narrow bandwidth low-speed signal. Since the feedback signal requires a much lower bandwidth, the feedback signal may be supplied via either a wired or wireless link. If via a wired link, the length of the wired link may be much longer than the distance between the two transceivers 100 and 200. If via a wireless link, the feedback signal is much more robust and reliable than the downlink video signal. In some embodiments, the feedback signal is carried on a two-way control channel. In other embodiments, the feedback signal is carried on a one-way control channel.

In some embodiments, the HDMI monitor 30 is a receive-only device while in other embodiments, the HDMI monitor 30 is configured to provide a monitor feedback signal. The monitor feedback signal may be used to inform a signal source of some aspect of the signal. For example, the monitor feedback signal may be used to inform the downlink transceiver 200 that a particular bit error rate is being encountered, the monitor is disabled (not being viewed), or a higher or lower quality signal is acceptable.

A broadcast from a distribution transceiver 100 may be meant for reception and display by a single monitor 30. The broadcast may be encrypted or otherwise encoded to limit a number of receiving monitors to a single monitor 30. Alternatively, the distribution transceiver 100 may broadcast a signal intended for reception by more than one monitor. For example, a user's home may have one monitor in the family room, a second monitor in the living room and a third monitor in the kitchen. The broadcast signal may still be encoded or encrypted such that a limited number of authorized monitors may receive and display a video signal.

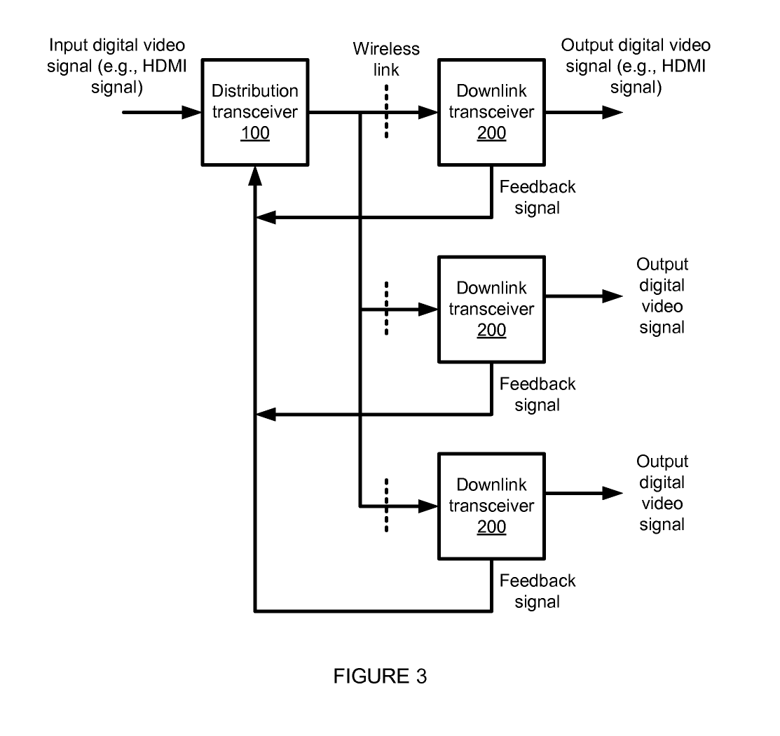

FIG. 3 shows an HDMI distribution system providing multiple digital video signals, in accordance with embodiments of the present invention. The system includes a distribution transceiver 100 receiving an input digital video signal, such as an HDMI signal, from a home theater 20 (not shown). The system also include more than one downlink transceiver 200 providing individual output digital video signals to separate monitors 30 (not shown). Each downlink transceiver 200 provides a feedback signal, which may be wired or wireless and which may be transmitted on a TDMA channel or other shared medium. In some embodiments, the distribution transceiver 100 broadcasts a common video signal for display on each monitor 30. In other embodiments, the distribution transceiver 100 broadcasts multiple video signals such that the downlink receiver 200 may select which video signal to display. In some embodiments, the distribution transceiver 100 broadcasts multiple video signals and a downlink receiver 200 select one or more of the multiple video signal to display, for example, as a picture-in-picture (PIP) mode.

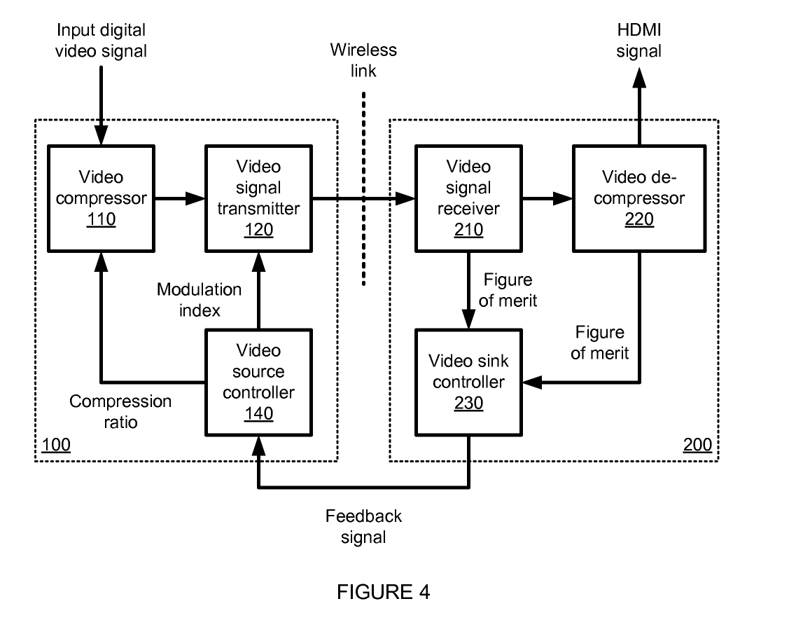

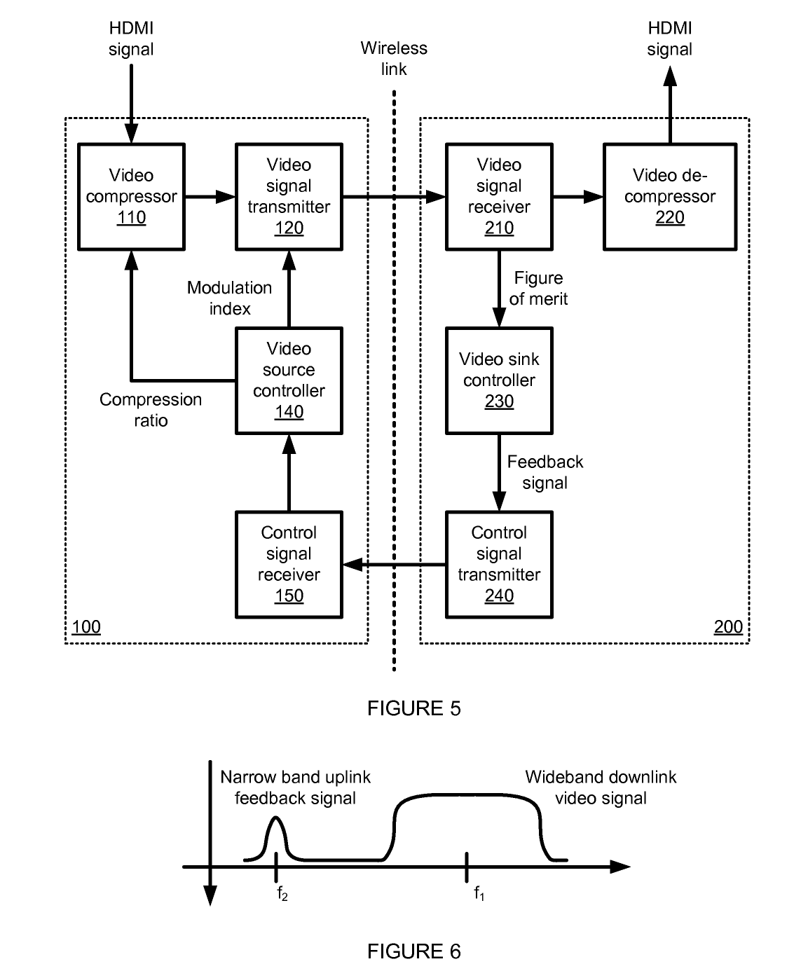

FIGS. 4 and 5 show block diagrams of a wireless HDMI system having a feedback signal, in accordance with embodiments of the present invention. In FIG. 4, the wireless system includes a distribution transceiver 100 having a video compressor 110, a video signal transmitter 120 and a video source controller 140. The system also includes a downlink receiver 200 having a video signal receiver 210, a video de-compressor 220 (or video expander) and a video sink controller 230. As described above, the distribution transceiver 100 receives an input digital video signal and a feedback signal and transmits a wireless video signal. The downlink receiver 200 receives the wireless video signal and generates the HDMI signal for the monitor 30 (not shown) and the feedback signal.

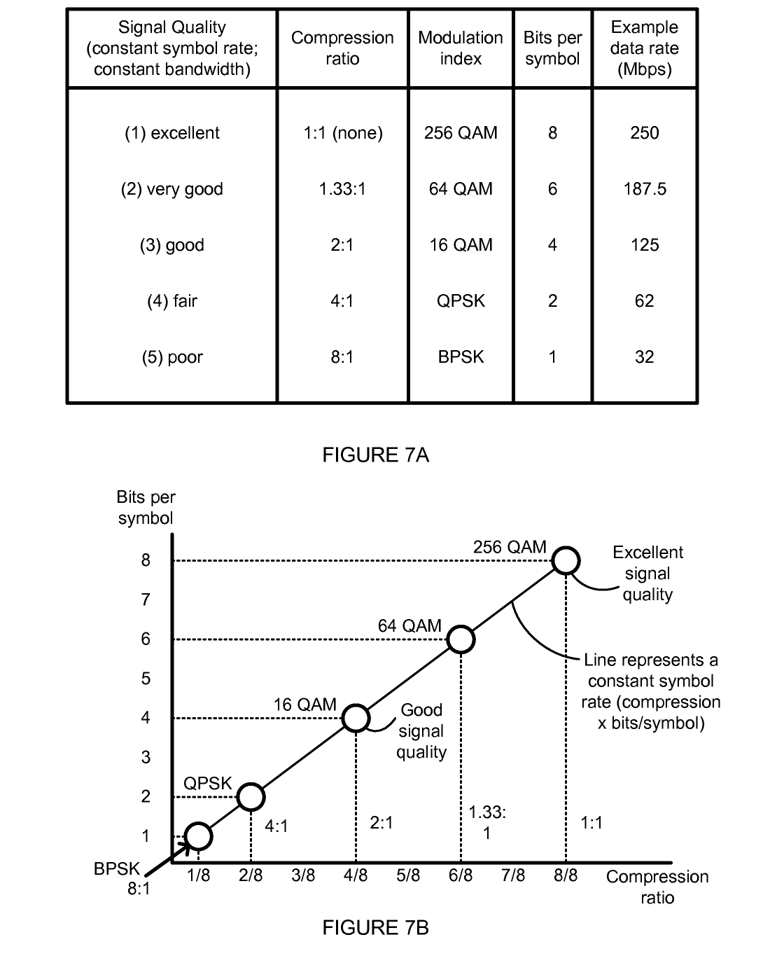

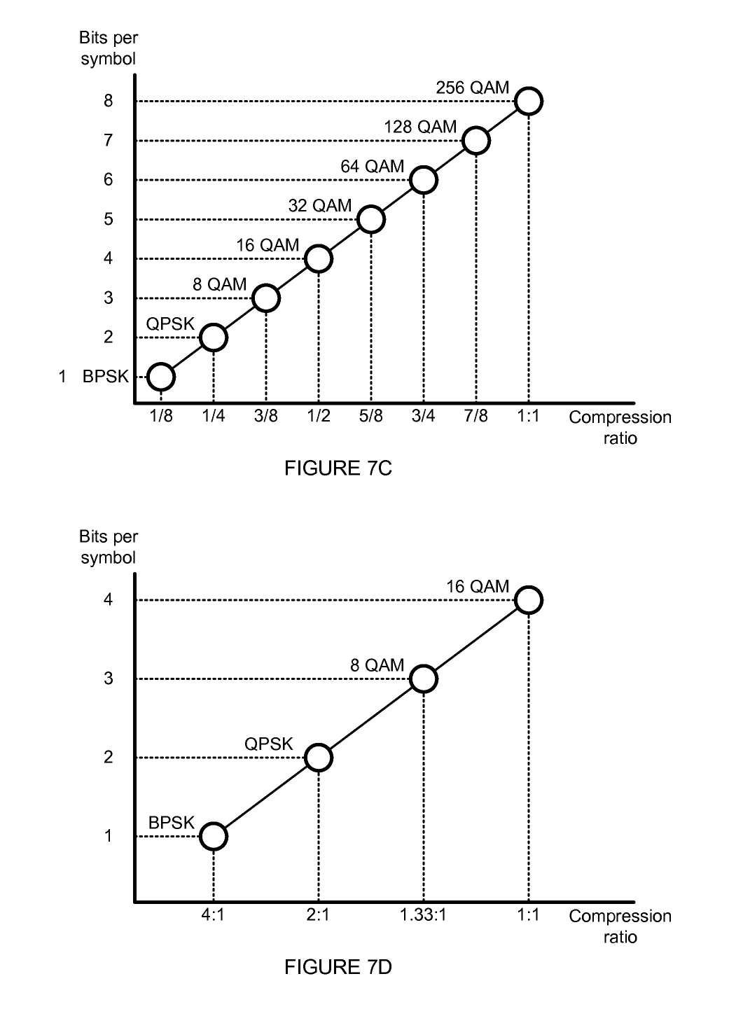

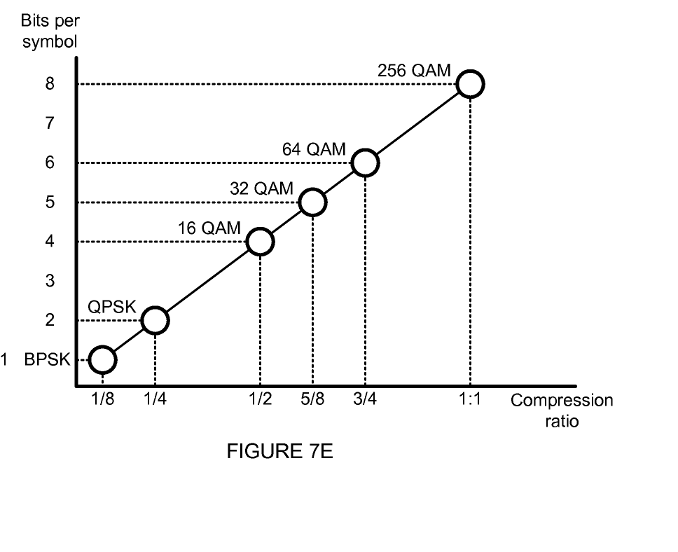

The video source controller 140 processes the feedback signal transmitted by the video sink controller 230. Based on the feedback signal, a current compression ratio and a current modulation index, the video source controller 140 may set an updated compression-ratio/modulation-index pair. The video compressor 110 accepts an input digital video signal and the set compression ratio. The video compressor 110 generates an output signal having the instructed level of compression. In some embodiments, the video compressor 110 performs lossy compression. In other embodiments, the video compressor 110 performs lossless compression. This compressed signal is provided to the video signal transmitter 120. The video signal transmitter 120 accepts this compressed signal along with the set modulation index control signal and generates and transmits a wireless output signal at the set modulation index. The compression ratio and modulation index are further described below with reference to FIGS. 7-10.

The video signal receiver 210 is a wireless receiver that demodulates the signal transmitted by transmitter 120. During demodulation, the video signal receiver 210 may report a figure of merit to indicate a signal quality, bit error rate, SNIR, RSSI, video drop out count or other representation of the received signal. The video signal receiver 210 provides a demodulated signal to the video de-compressor 220 and the figure of merit to the video sink controller 230. The video sink controller 230 uses the figure of merit to generate a feedback signal. The feedback signal may contain the figure of merit, a filtered version of a sequence of figures of merit, or other indirect indication to change to a new compression-rate/modulation-rate pair. Alternatively, feedback signal may contain a direct indication to change to a new compression-rate/modulation-rate pair. For example, the feedback signal may contain an indication to change to a next better pair to accommodate an improved channel or to change to a next more robust pair to accommodate a deteriorating channel. The video de-compressor 220 processes the demodulated signal to reverse the compression imposed by the video compressor 110. The decompression process may not completely reverse the effect of compression when lossy compression is employed. In turn, the video de-compressor 220 provides a wired HDMI signal for use by the monitor 30. In alternative embodiments, the video de-compressor generates a figure of merit indicating the quality of the demodulated signal. This alternative or additional figure a merit is similarly sent to and processed by the video sink controller 230.

In FIG. 5, the feedback portion of system of FIG. 4 is shown in more detail. The feedback signal generated by the video sink controller 230 is transmitted wirelessly by a control signal transmitter 240 in the downlink transceiver 200 and received by a control signal receiver 150 in the distribution transceiver 100. If the control signal transmitter 240 and control signal receiver 150 may be designed as replaceable modules to allow alternative wireless standards to be used. In FIG. 5, the feedback signal is transmitted on a one-way link. In alternative embodiments, the feedback signal may be transmitted between transceivers providing a two-way control link.

FIG. 6 illustrates a spectrum containing a wideband downlink video signal and a narrow band uplink feedback signal. The downlink video signal is a wideband signal centered on a carrier frequency f₁, while the uplink feedback signal is a narrow band signal centered at a lower carrier frequency f₂. The higher carrier frequency f₁ supports the wide bandwidth signal but is less robust than the narrowband signal at carrier frequency f₂. This combination a high data rate downlink signal and a high robustness uplink signal allows the downlink signal to carry a controlled volume of video information while allowing the uplink signal to report any loss in downlink signal quality, for example, when the downlink signal is below a desired signal quality.

FIGS. 7A, 7B, 7C, 7D and 7E show various predetermined pairings of compression ratios and modulation indexes, in accordance with embodiments of the present invention. The compression is lossy in some embodiments while lossless in other embodiments.

In FIGS. 7A and 7B, a table and a chart, respectively, define five predetermined pairs of various compression ratios and modulation indexes, in accordance with embodiments of the present invention. The video source controller 140 (shown in FIGS. 4 and 5) maintains a common symbol rate and constant video signal bandwidth by controlling the compression ratio and the modulation index used in the distribution transceiver 100. The constant compression ratio may be set generically by pairing a first compression ratio defined as 2^{M}:1 and a first modulation index of 2^{N}-QAM. The second compression ratio is set to 2^{2*M}:1 and a second modulation index is set to 2^{N/2}-QAM. For example, let M=1 and N=4. In this case, a first of the predetermined pairs is defined by the first compression ratio of 2:1 (where M=1 and 2^{M}=2¹=2) and the first modulation index of 16-QAM (where N=4 and 2^{N}=2⁴=16). The second compression ratio is set to 4:1 (from 2^{2*M}=2^{2*1}=2²=4) and the second modulation index is set to 4-QAM or QPSK (from 2^{N/2}=2^{4/2}=2²=4). The common symbol rate is also highlighted by the line formed by the predetermined points representing compression ratio and figure of merit pairs.

As described above, the downlink receiver 200 determines a figure of merit based on the quality of the received digital video signal. The video source controller 140 reads the figure of merit, which indicates a quantized level of received signal quality. For example, the figure of merit may indicate if a received signal is (1) excellent, (2) very good, (3) good, (4) fair or (5) poor. For each quantized level of signal quality, a compression ratio and modulation index pair is predetermined. As such, if a signal quality is excellent, then the highest modulation index is used. If a signal quality is poor, then the lowest modulation index is used.

For example, if the signal quality is excellent, the signal may be transmitted uncompressed (1:1) using a modulation index for 256-QAM. For each successive reduction of signal quality, a higher compression ratio with a lower modulation index is used. For example, signal with a very good signal quality is compressed at a rate of 1.33:1 and transmitted using 64-QAM. A signal with a good signal quality is compressed at a rate of 2:1 and transmitted using 16-QAM. A signal with a fair signal quality is compressed at a rate of 4:1 and transmitted using QPSK (4-QAM). A signal with a poor signal quality is compressed at a rate of 8:1 and transmitted using BPSK (2-QAM).

In this example, assume an uncompressed video signal is streamed at 8 Mbps and symbols are transmitted at a common symbol rate of 1 Msps (million symbols per second). These rates are selected for mathematical convenient. With no compression (1:1), the video signal is transmitted with 8-bit symbols (256 QAM) at the 1-Msps common symbol rate. When compressed by approximately 1.33:1 compression, the 8-Mbps stream is converted to a 6-Mbps stream. Therefore, a lower modulation index may be used. Using 6-bit symbols (64-QAM), the resulting common symbol rate to transmit the 6-Mbps compressed video stream is 1 Msps. When compressed by 2:1 compression, the 8 Mbps stream is converted to 4 Mbps. Using 4-bit symbols (16-QAM), the 4-Mbps compressed video stream is again transmitted at the common symbol rate of 1 Msps. When compressed by 4:1 compression, the 8 Mbps stream is converted to 2 Mbps. Using 2-bit symbols (QPSK), transmission of the 2-Mbps compressed video stream results in a symbol rate of 1 Msps. When compressed by 8:1 compression, the 8 Mbps stream is converted to 1 Mbps. Using 1-bit symbols (BPSK), the 1-Mbps compressed video stream is also transmitted at a symbol rate of 1 Msps.

FIG. 7D shows a third predetermined relationship pairing four sets of compression ratios and modulation indexes. In this embodiment, a signal may be uncompressed (1:1) or compressed at various levels from 3/4 (1.33:1), 1/2 (2:1) and 1/4 (4:1). The paired modulation indexes are 16-QAM (4-bit symbols), 8-QAM (3-bit symbols), QPSK (2-bit symbols) and BPSK (1-bit symbols), respectively.

FIG. 7E shows a fourth predetermined relationship pairing six sets of compression ratios and modulation indexes. In this embodiment, a signal may be uncompressed (1:1) or compressed at various levels from 3/4 (1.33:1), 5/8 (1.6:1), 1/2 (2:1), 1/4 (4:1) and 1/8 (8:1). The paired modulation indexes are 256-QAM (8-bit symbols), 64-QAM (6-bit symbols), 32-QAM (5-bit symbols), 16-QAM (4-bit symbols), QPSK (2-bit symbols) and BPSK (1-bit symbols), respectively.

As shown in FIGS. 7B, 7C, 7D and 7E, the charts comparing compression ratios to the number of bits per symbol for a given modulation index. Each sequential pairing produces a point on a monotonically increasing curve, in accordance with the present invention.

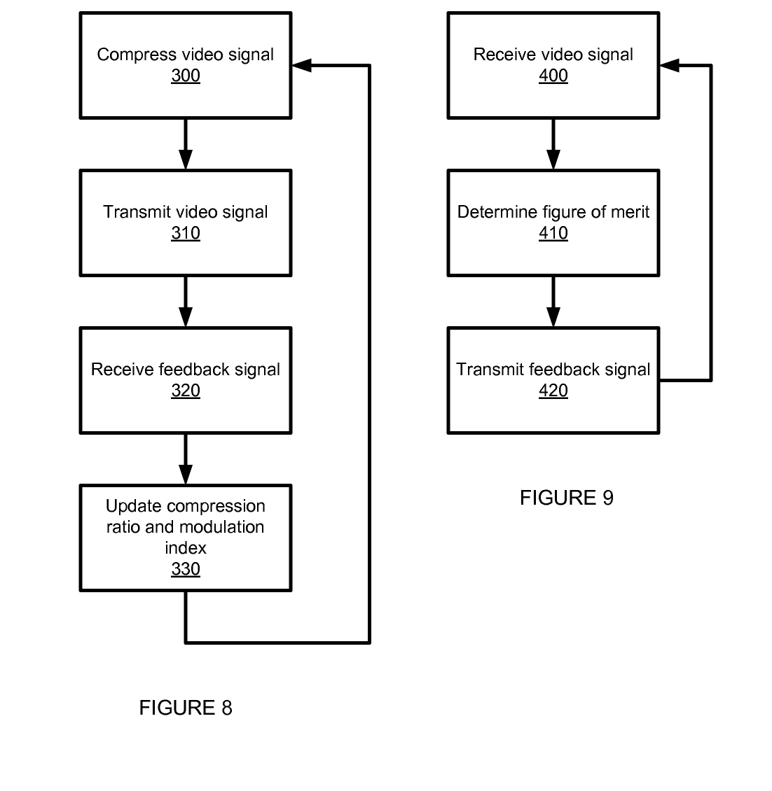

FIGS. 8, 9 and 10A show flow charts of operations in a HDMI distribution system, in accordance with embodiments of the present invention. As performed in a distribution transceiver 100, FIG. 8 shows at step 300 in which a video signal is compressed at a predetermined compression rate. At step 310, the video signal is transmitted using a predetermined modulation index from the distribution transceiver 100 to a downlink transceiver 200. Next at step 320, a feedback signal is received at the distribution transceiver 100 from the downlink transceiver 200. Finally at step 330, the compression ratio and modulation index are updated and the process repeats. In practice, compression 300 and transmission 310 are continually performed on an input stream of data. Step 320 occurs periodically or when the downlink transceiver 200 provides a new feedback signal. Step 330 only occurs in response to step 320 indicating a sufficient change in signal reception quality.

As performed in a downlink transceiver 200 and shown in FIG. 9 beginning at step 400, receiving the video signal. At step 410, a figure of merit is determined based on the received signal. At step 420, the feedback signal is generated based on the figure of merit and transmitted from the downlink transceiver 200 to the distribution transceiver 100.

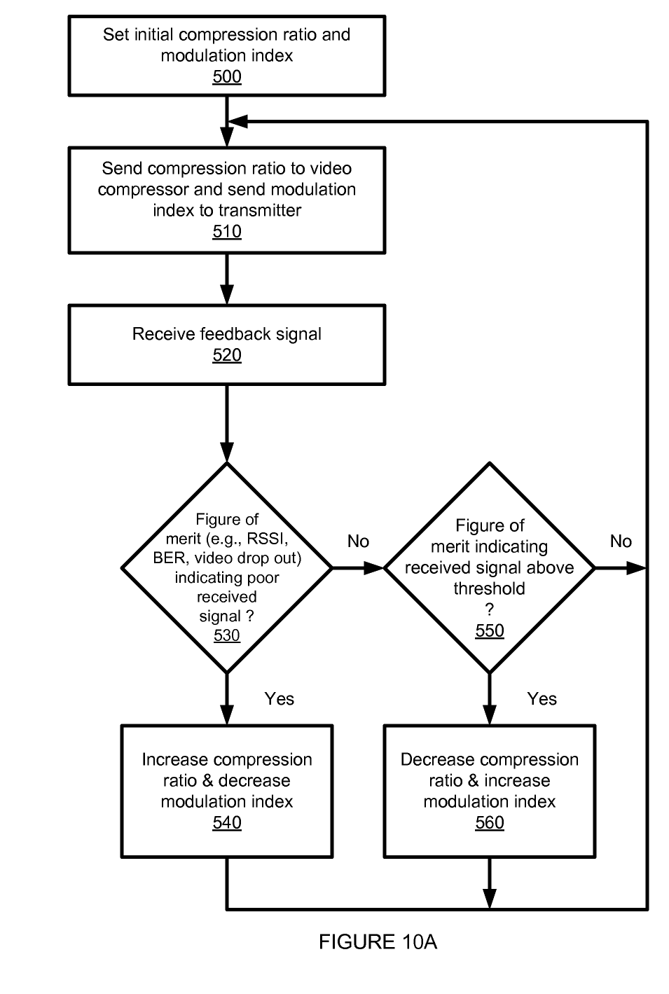

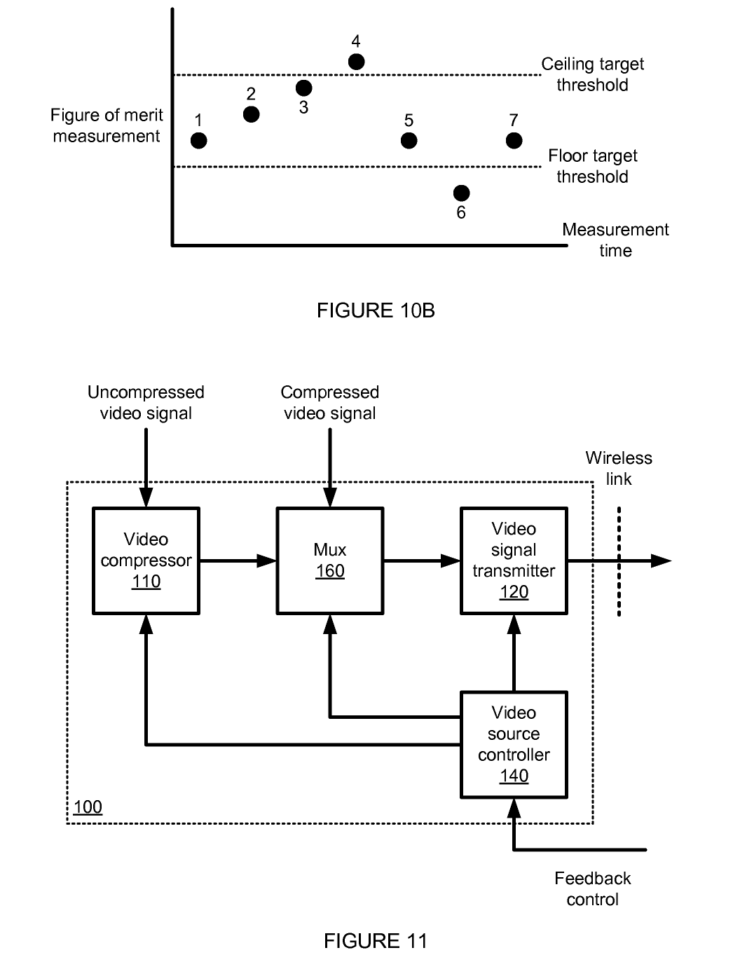

FIGS. 10A and 10B illustrate a process of changing which pair of compression ratio and modulation index is used, in accordance with embodiments of the present invention. FIG. 10A shows a more detailed embodiment of the video source controller 140. At step 500, a compression ratio and modulation index pair are initially set. In some embodiments, the initial pair indicates a maximum available compression ratio and a lowest modulation index. For the example shown in FIG. 7A and 7B, an initial pair of compression ratio (8:1) and modulation index (BPSK) used for poor signals is used. In other embodiments, the last working pair is loaded from memory. That is, each time a pair is selected, an index for that pair may be saved to non-volatile memory for use during initialization.

At step 510, the selected compression ratio is sent to the video compressor 110 and the paired modulation index is sent to the video signal transmitter 120. At step 520, the video source controller 140 receives a feedback signal. This feedback signal may either be received from the downlink transceiver 200 or alternatively due to an error condition occurring when a timeout occur after waiting for but not receiving a feedback signal.

Next, the feedback signal is examined to determine whether it is necessary or desirable to switch to a different pair of compression ratio and modulation index. At step 530, the figure of merit is compared to a first target threshold (floor). If the figure of merit falls below this floor target threshold, as shown in step 540, the compression ratio is increased and the modulation index is decreased. The process then continues with the new pair at step 510.

If the figure of merit does not fall below this floor target threshold, processing continues at step 550, where the figure of merit is compared to a second threshold (ceiling). If the figure of merit rises above this ceiling target threshold, as shown in step 560, the compression ratio is decreased and the modulation index is increased. The process then continues with the new pair at step 510.

If the figure of merit does not fall outside the floor to ceiling target threshold range, the current pair of compression ratio and modulation index is left unchanged. The figures of merit examined by steps 530 and 550 may represent an individual measurement or alternatively may result from a low pass filtering of a series measurements. Additionally, the process of tracking a figure of merit and determining whether to leave the pair unchanged, advance the pairing for an improved channel or retreat the pairing for a deteriorating channel may be performed in the distribution transceiver 100, for example in the video source controller 140, as described above. Alternatively, the process may be performed in the downlink transceiver 200 or partially in the distribution transceiver 100 and partially in the downlink transceiver 200.

FIG. 10B illustrates a series of seven sequential figure of merit values. The first, second and third values fall below the ceiling target threshold and above the floor target threshold. In this case, the paired compression ratio and modulation index are left unchanged. Measurement four however represents a figure of merit value that is above the ceiling target threshold. In this case, the transmitted signal may be modified to a higher modulation index. That is, the channel may have capacity to support a higher modulation index and thus may supply a signal having less compression loss. Once the modulation index is changed to a higher index, future figure of merit measurement typically are lower thereby bringing the fifth value within the ceiling and floor target threshold.

If the channel conditions worsen, the figure of merit measurements may worsen as is illustrated with the sixth value, which is below the floor target threshold. In this case, the transmitted signal may be modified to a lower modulation index. That is, the channel may have worsened and may no longer have the capacity to support the current modulation index. As a result, the modulation index is reduced and the compression is increase causing a signal with greater information loss.

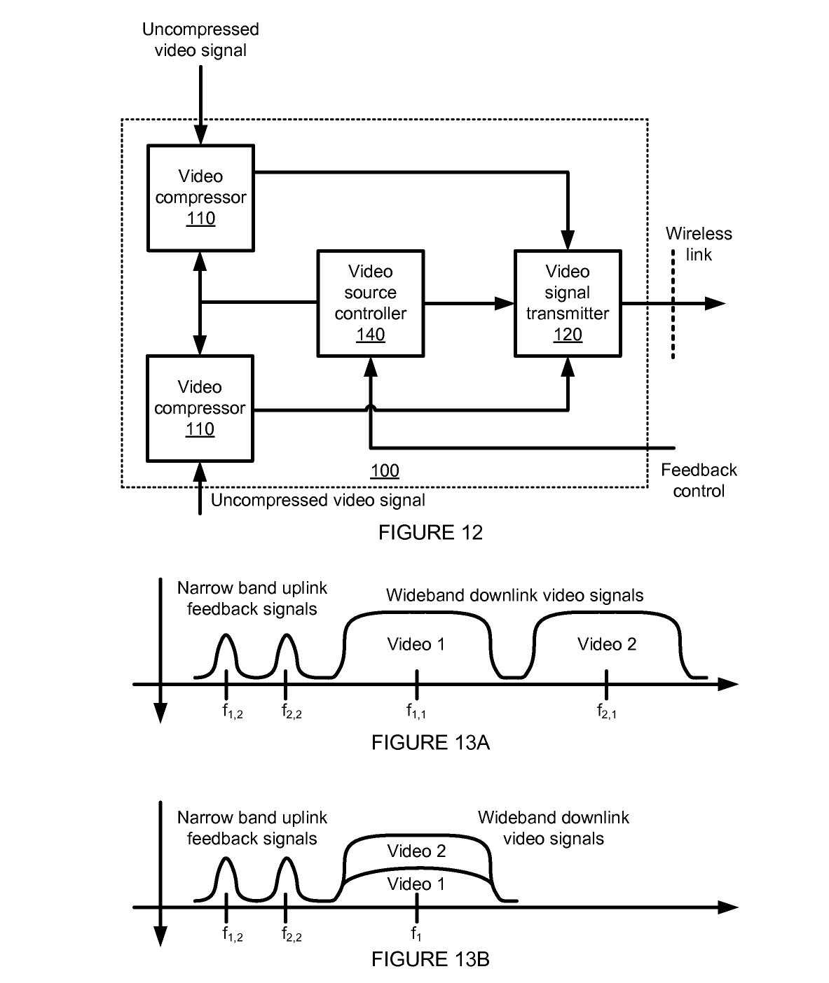

FIGS. 11 and 12 show block diagrams of wireless HDMI systems having multiple video signal input ports, in accordance with embodiments of the present invention. The wireless system of FIG. 11 includes, as described with reference to FIG. 4, a distribution transceiver 100 having a video compressor 110, a video signal transmitter 120 and a video source controller 140 and also includes a multiplexer (mux) 160. The mux 160 is designed between the video compressor 110 and the video signal transmitter 120 and is controlled by the video source controller 140. The mux 160 selectively forwards either the video signal output from the video compressor 110 or the compressed video signal provided externally to the distribution transceiver 100. When the externally provided compressed video signal is selected by the controller 140 for passing through the mux 160, the controller 140 also provides the appropriate predetermined paired modulation index to the video signal transmitter 120.

The wireless system of FIG. 11 shows a distribution transceiver 100 that includes two video compressors 110 controlled by the video source controller 140. Both video compressors 110 provide a compressed signal to the video signal transmitter 120, which transmits a selected one of the video signals. In alternative embodiments, the video signal transmitter 120 transmits both of the compressed video signals.

In alternative embodiment, a distribution transceiver 100 includes a video de-compressor to expand compressed video before compressing again at a selected compression ratio. That is, a compressed signal is first uncompressed. Next, the video source controller 140 selects a pair of compression ratio and a modulation index from a list that are predetermined (described above with reference to FIGS. 7A-7D). In this manner, the distribution transceiver 100 processes new video data that is pre-compressed by uncompressing the signal from its original compression rate then recompressing it at a rate partnered with a modulation rate.

FIGS. 13A and 13B illustrate spectrums containing wideband downlink video signals and narrow band uplink feedback signals. In FIG. 13A, the spectrum contains two wideband downlink video signals and two narrow band uplink feedback signals. The downlink video signal are each a wideband signal centered on a carrier frequency f_{1,1} or f_{2,1}, respectively. The uplink feedback signals are each a narrow band signal centered at a lower carrier frequency f_{1,2} or f2,2, respectively. The higher carrier frequencies f_{1,1} and f_{2,1} each support a wide bandwidth signal but is less robust than the narrowband signals at carrier frequency f_{1,2} or f2,1. This combination a high data rate downlink signal and a high robustness uplink signal allows the downlink signal to carry a controlled volume of video information while allowing the uplink signal to report any loss in downlink signal quality, for example, when the downlink signal is below a desired signal quality.

In FIG. 13B, the spectrum also contains two wideband downlink video signals and two narrow band uplink feedback signals. The two wideband downlink video signals are both transmitted using a common carrier frequency f₂ but each a narrow band signal is centered at a separate lower carrier frequency f_{1,2} or f_{2,2}.

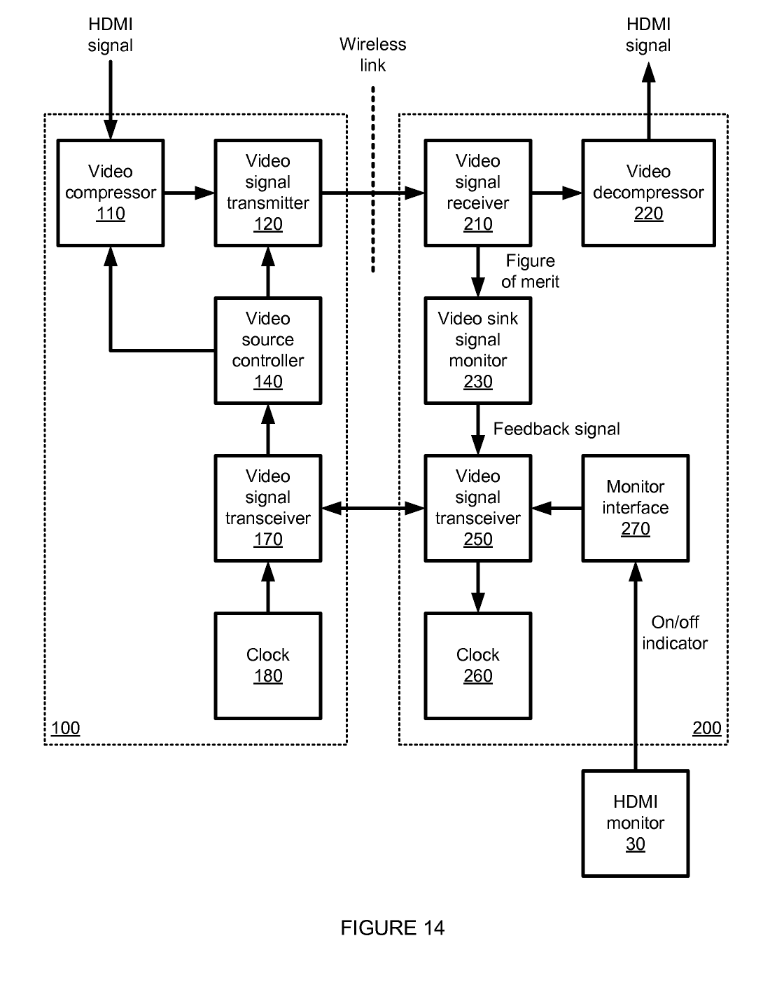

FIG. 14 shows block diagrams of wireless HDMI systems having an HDMI monitor interface, in accordance with embodiments of the present invention. The figure shows the block diagram of FIG. 4 with the following additions. The distribution transceiver 100 includes a video signal transceiver 170 and a clock 180. The clock 180 drives the video signal transceiver 170, which transmits a clock signal for use by each downlink transceiver 200. The downlink transceiver 200 also includes a video signal transceiver 250, which receives the clocking signal from the transceiver 170 of the distribution transceiver 100. The video signal transceiver 250 instructs its local clock 260 such that is synchronized with the remote clock 180.

In addition to the video signal transceiver 250 and the clock 260, the downlink transceiver 200 also includes a monitor interface 270, which receives an indication from the HDMI monitor 30 regarding the monitor's on/off setting. For example, when the HDMI monitor is off, the monitor interface 270 will recognize that the monitor is not displaying a video image and provide a signal, via the video signal transceiver 250, to the distribution transceiver 100. The video source controller 140 will receive this on/off indication from its video signal transceiver 170. If the distribution transceiver 100 is broadcasting to a single downlink transceiver 200, the video source controller 140 may stop transmitting the wireless video signal from transmitter 120. The video source controller 140 may also put other components, such as the video compressor 110, into an inactive or powered-down state.

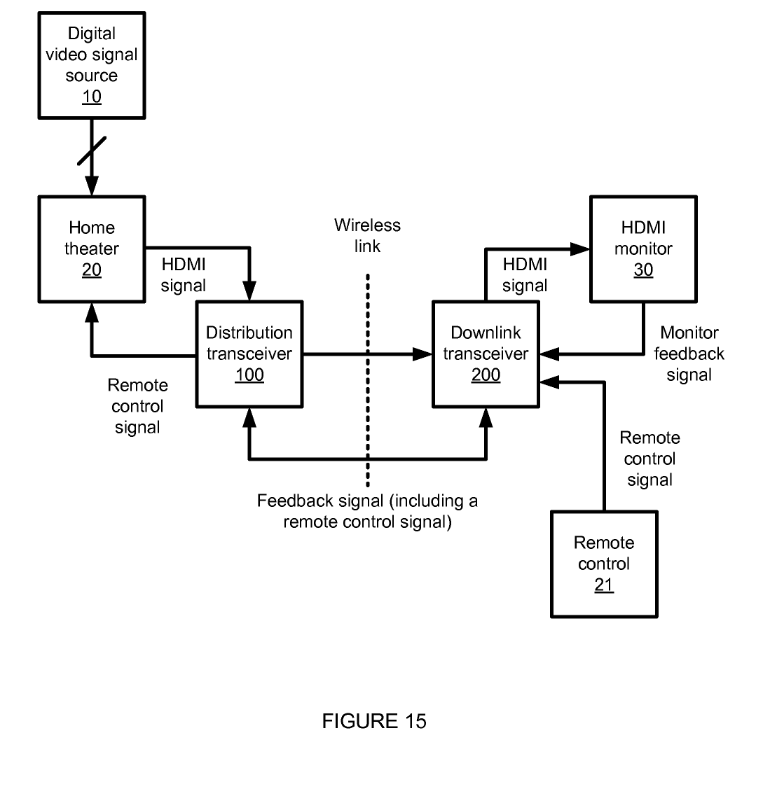

FIG. 15 shows a hardware configuration for sending and receiving remote control commands, in accordance with some embodiments of the present invention. Here, the embodiment of FIG. 2 is supplemented with remote control capability. A remote control 21 provides a remote control signal carrying remote control commands from the remote control 21 to a downlink transceiver 200. This remote control signal may be a standard infrared (IR) signal (or alternatively, an RF signal). If an IR signal, the downlink transceiver 200 includes an IR receiver (not shown) coupled to its controller 230 (FIG. 4) to receive the IR signal and the remote control commands. The controller 230 integrates the IR commands into the feedback signal, which it transmits on the uplink channel. A controller 140 (FIG. 4) in the transceiver 100 receives the feedback signal and now extracts the remote control commands from the feedback signal. The remote control commands are fed into an IR transmitter and translated back to an IR signal by re-transmits the IR signal from the transceiver 100 to the home theater unit 20 and/or the video signal source 10, thus simulating the IR signal from the remote control 21. This configuration effectively augments a standard IR remote control 21 with RF range capability via the RF feedback uplink thereby allowing control of the video source components 10 and 20 over the same narrowband wireless path used for the feedback control signals. This configuration allows one or more remote controls 21 meant to operator near and within a line of sight of the home theater 20 and/or the video source 10 components to function beyond a maximum length of an IR signal. Therefore, such a configuration allows a user to change channels or make other adjustments to the upstream components at a distance greater than provided for by typical IR remote control signals.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration. For example, HDMI signals have been used above to describe various embodiments of the present invention. Other HD multimedia signals may also be processed in an equivalent manner.

What is claimed is:

1. A distribution transceiver for communicating a digital video signal, the transceiver comprising:
a video compressor comprising (1) an input port to accept an input digital video signal, (2) digital compressing logic operable to compress the input digital video signal at a selected compression ratio, (3) an output port to provide a compressed digital video signal, and (4) a control input port couple to receive a control signal indicating the selected compression ratio;
a video signal transmitter comprising (1) an input port configured to receive the compressed digital video signal from the video compressor, (2) a modulator, (3) an output port configured to transmit, on a downlink, an RF signal at a selected modulation rate, and (4) a control input port couple to receive a control signal indicating the selected modulation rate; and
a video source controller comprising (1) a first port configured to provide the selected compression ratio as the control signal to the control input port of the video compressor, (2) a second port configured to provide the selected modulation rate as the control signal to the video signal transmitter, and (3) a third port configured to accept, from a uplink, a feedback signal;
wherein the video source controller is configured to select a compression-rate/modulation-rate pair from a list of pairs having a common symbol rate; and
wherein the downlink is narrower and independent from the uplink.

2. The distribution transceiver of claim 1, wherein the video compressor comprises a lossy compressor.

3. The distribution transceiver of claim 1, wherein the video compressor comprises a lossless compressor.

4. The distribution transceiver of claim 1, further comprising a multiplexer coupled to transmit to the input port of the video signal transmitter a selected one of the compressed digital video signal from the output port of the video compressor and a second compressed video signal.

5. The distribution transceiver of claim 1, wherein, if the selected compression ratio equals 1:1, the video compressor passes the input digital video signal as the compressed digital video signal.

6. The distribution transceiver of claim 1, wherein the list of pairs having the common symbol rate comprises:
a compression ratio of 2^{M}:1 and a modulation index of 2^{N}-QAM; and
a compression ratio of 2^{2*M}:1 and a modulation index of 2^{N/2}-QAM.

7. The distribution transceiver of claim 1, wherein the list of pairs having the common symbol rate comprises:
a compression ratio of 1:1 and a modulation index of 256-QAM; and
a compression ratio of 2:1 and a modulation index of 16-QAM.

8. The distribution transceiver of claim 1, wherein the feedback signal comprises an indication to change to a new compression-rate/modulation-rate pair.

9. The distribution transceiver of claim 8, wherein the feedback signal comprises a figure of merit.

10. The distribution transceiver of claim 9, wherein the figure of merit comprises a received signal strength indication (RSSI).

11. The distribution transceiver of claim 9, wherein the figure of merit comprises a bit error rate (BER).

12. The distribution transceiver of claim 9, wherein the figure of merit comprises an video drop-out indicator.

13. The distribution transceiver of claim 1, wherein the input digital video signal comprises a high-definition multimedia interface (HDMI) signal.

14. A downlink transceiver for communicating a digital video signal, the downlink comprising:
a video signal receiver comprising (1) an input port configured to receive, on a downlink, a compressed digital video signal, (2) a demodulator, and (3) an output port configured to provide a demodulated signal; and
a video decompressor comprising (1) an input port to accept the demodulated signal, (2) digital decompressing logic operable to decompress the demodulated signal, and (3) an output port to provide a decompressed digital video signal;
a video sink monitor configured to (1) receive a signal indicating a signal quality, and (2) provide a feedback signal based on the signal quality; and
a control signal transmitter configured to transmit, on an uplink, the feedback signal;
wherein at least on of the signal receiver and the video decompressor further comprises and (4) a control output port couple to provide the signal indicating a signal quality;
wherein the feedback signal is used to select a compression-rate/modulation-rate pair from a list of pairs having a common symbol rate; and
wherein the downlink is narrower and independent from the uplink.

15. A method for distributing a digital video signal, the method comprising:
setting a first compression-rate/modulation-rate pair comprising a selected compression rate and a selected modulation rate; and
repeating acts of
accepting an input digital video signal;
compressing the input digital video signal at the selected compression rate, thereby providing a compressed digital video signal;
modulating the compressed digital video signal at the selected modulation rate, thereby transmitting a wireless signal;
receiving a feedback signal indicating a signal of merit of the wireless signal received at a downlink transceiver;
selecting, from a list of pairs having a common symbol rate, a compression-rate/modulation-rate pair based on the feedback signal; and
updating the selected compression rate and the selected modulation rate using the selected compression-rate/modulation-rate pair.

16. The method of claim 15, further comprising passing the input digital video signal as the compressed digital video signal, if the selected compression ratio equals 1:1.

17. The method of claim 15, wherein the list of pairs having the common symbol rate comprises:
a compression ratio of 2^{M}:1 and a modulation index of 2^{N}-QAM; and
a compression ratio of 2^{2*M}:1 and a modulation index of 2^{N/2}-QAM.

18. The method of claim 15, wherein the list of pairs having the common symbol rate comprises:
a compression ratio of 1:1 and a modulation index of 256-QAM; and
a compression ratio of 2:1 and a modulation index of 16-QAM.

19. The method of claim 15, wherein the feedback signal comprises a figure of merit.

20. The method of claim 19, wherein the feedback signal comprises a figure of merit.

21. The method of claim 20, wherein the figure of merit comprises a received signal strength indication (RSSI).

22. The method of claim 20, wherein the figure of merit comprises a bit error rate (BER).

23. The method of claim 20, wherein the figure of merit comprises a video drop-out indicator.

24. The method of claim 15, wherein the input digital video signal comprises a high-definition multimedia interface (HDMI) signal.

25. The method of claim 15, further comprising disabling the transmitter if the feedback signal indicates a remote monitor is disabled.

26. The method of claim 15, further comprising receiving a second feedback signal indicating a signal of merit of a wireless signal received at a second downlink transceiver.
